(19) United States
(12) Patent Application Publication
(10) Pub. No.: US 2022/0375476 A1
(43) Pub. Date: Nov. 24, 2022

(54) SPEAKER AUTHENTICATION SYSTEM, METHOD, AND PROGRAM

(71) Applicant: NEC Corporation, Minato-ku, Tokyo (JP)

(72) Inventor: Satoru MOMIYAMA, Tokyo (JP)

(73) Assignee: NEC Corporation, Minato-ku, Tokyo (JP)

(21) Appl. No.: 17/764,288

(22) PCT Filed: Oct. 17, 2019
(86) PCT No.: PCT/JP2019/040805

§ 371 Date: Mar. 28, 2022

(51) Int. Cl. G10L 17/06; G10L 17/02; G10L 25/18

(52) U.S. Cl. CPC G10L 17/06; G10L 17/02; G10L 25/18

(57) ABSTRACT

Provided is a speaker authentication system capable of achieving robustness against adversarial examples. A data storage unit 112 stores data related to voice of a speaker. A plurality of voice processing units 11 respectively perform speaker authentication based on input voice and the data stored in the data storage unit 112. A post-processing unit 116 specifies one speaker authentication result based on speaker authentication results obtained respectively by the plurality of the voice processing units 11. A method or parameters of the pre-processing applied to the voice in each voice processing unit 11 are different for each voice processing unit 11.

### TECHNICAL FIELD

The present invention relates to a speaker authentication system, a speaker authentication method, and a speaker authentication program.

### BACKGROUND ART

Human voice is a type of biometric information, which is unique to an individual. Therefore, voice can be used for biometric authentication to identify an individual. Biometric authentication using voice is called speaker authentication.

FIG. 11 is a block diagram showing an example of a general speaker authentication system. The general speaker authentication system 40 shown in FIG. 11 includes a voice information storage device 420, a pre-processing device 410, a feature extraction device 430, a similarity calculation device 440, and an authentication device 450.

The voice information storage device 420 is a storage device for registering voice information of one or more speakers in advance. Here, it is assumed that voice information of each speaker is registered in the voice information storage device 420, which is obtained by performing the same pre-processing on voice of each speaker as that performed by the pre-processing device 410 on input voice.

The pre-processing device 410 performs pre-processing on voice input through a microphone or the like. In this pre-processing, the pre-processing device converts the input voice into a format that is easy for the feature extraction device 430 to extract features of the voice.

The feature extraction device 430 extracts features of voice from voice information obtained by pre-processing. This feature can be said to express the characteristics of the of a speaker. The feature extraction device 430 also extracts features from the voice information of each speaker registered in the voice information storage device 420.

The similarity calculation unit 440 calculates a similarity between a feature of each speaker extracted from each voice information registered in the voice information storage device 420 and a feature of the voice (input voice) to be authenticated.

The authentication device 450 determines which voice of each speaker the input voice is from among the speakers whose voice information is registered in the voice information storage device 420 by comparing a similarity calculated for each speaker with a predetermined threshold value.

An example of a speaker authentication system shown in FIG. 11 is described in Non-Patent Literature 1. The operation of the speaker authentication system described in Non-Patent Literature 1 will be explained. It is assumed that voice information of each speaker is registered in the voice information storage device 420 in advance, which is obtained by performing the same pre-processing on voice of each speaker as that performed by the pre-processing device 410.

The voice to be authenticated is input to the speaker authentication system 40 through an input device such as a microphone. The input voice may be limited to a voice that reads out a specific word or sentence. The pre-processing device 410 converts the voice into a format that is easy for the feature extraction device 430 to extract the features of the voice.

Next, the feature extraction device 430 extracts features from the voice information obtained by pre-processing. Similarly, the feature extraction device 430 extracts features from the voice information registered in the voice information storage device 420 for each speaker.

Next, the similarity calculation device 440 calculates a similarity between a feature of each speaker and a feature of voice to be authenticated, for each speaker. As a result, features are obtained for each speaker.

Next, the authentication device 450 determines which voice of a speaker the input voice is by comparing a similarity obtained for each speaker with a threshold value. Then, the authentication device 450 outputs the determination result (a speaker authentication result) to an output device (not shown).

Since a biometric system, such as the general speaker authentication system described above, is used to authenticate individuals, the biometric system may play a role in ensuring the security of other systems. In this case, there can be an adversarial attack that can erroneously authenticate the biometric system.

An example of a technique for realizing a biometric system that is robust against such an adversarial attack is described in Non-Patent Literature 2. The technique described in Non-Patent Literature 2 is a defensive technique against an attack that pretends to be a specific speaker. Specifically, the technology described in Non-Patent Literature 2 determines whether the input voice is voice of a spoofing attack or normal voice by operating multiple different speaker authentication devices and spoofing attack detection devices in parallel and integrating the results.

FIG. 12 is a schematic diagram showing a spoofing attack defense system described in Non-Patent Literature 2. The spoofing attack defense system described in Non-Patent Literature 2 includes a plurality of speaker authentication devices 511-1, 511-2, . . . , 511-i, a plurality of spoofing attack detection devices 512-1, 512-2, . . . , 512-j, an authentication result integration device 513, a detection result integration device 514, and an authentication device 515. When the speaker authentication devices are not specifically distinguished, they may be denoted simply by the code “511”. Similarly, when the spoofing attack detection devices are not specifically distinguished, they may be denoted simply by the code “512”. In FIG. 12, an example, in which the number of speaker authentication devices 511 is i, and the number of spoofing attack detection devices 512 is j, is illustrated.

Speaker authentication devices 511-1, 511-2, . . . , 511-i each operate as stand-alone speaker authentication devices. Similarly, spoofing attack detection devices 512-1, 512-2, . . . , 512-j operate as stand-alone spoofing attack detection devices.

The authentication result integration device 513 integrates the authentication results of multiple speaker authentication device 511. The detection result integration device 514 integrates the output results of multiple spoofing attack detection devices 512. The authentication device 515 further integrates the result from the detection result integration device 514 and the result from the detection result integration device 514 to determine whether or not the input voice is a spoofing attack.

The operation of the spoofing attack defense system described in Non-Patent Literature 2 will be explained. The voice to be authenticated is input to all of the multiple speaker authentication devices 511 and all of the multiple spoofing attack detection devices 512 in parallel.

In the speaker authentication device 511, voice of multiple speakers is registered. Then, the speaker authentication device 511 calculates an authentication score for the input voice for each speaker whose voice is registered, and outputs the authentication score of the speaker who is finally authenticated. Thus, one authentication score is output from each speaker authentication device 511. The authentication score is a score used to determine whether the input voice originates from the speaker.

Each of the spoofing attack detection devices 512 outputs a detection score. The detection score is a score used to determine whether the input voice is a spoofing attack or a natural voice.

The authentication result integration device 513 calculates an integrated authentication score by performing an operation to integrate all the authentication scores output from each speaker authentication device 511, and outputs the integrated authentication score. The detection result integration device 514 calculates an integrated detection score by performing an operation to integrate all the detection scores output from each spoofing attack detection device 512, and outputs the integrated detection score.

The authentication device 515 performs an operation to integrate the integrated authentication score and the integrated detection score to obtain a final score. Then, the authentication device 515 determines whether the input voice is voice of a spoofing attack or not by comparing the final score with a threshold value, and if the input voice is a natural voice, the authentication device 515 determines which speaker the voice originates from that is registered in the authentication device 511.

Another technique for combating unauthorized voice input is described in Patent Literature 1.

An example of a speaker authentication method is also described in Patent Literature 2.

Patent Literature 3 describes a voice recognition system. Patent Literature 3 describes a voice recognition system including two voice recognition processing units that perform voice recognition using a unique recognition method.

### CITATION LIST

### Patent Literature

PTL 1: Japanese Patent Application Laid-Open No. 2016-197200
PTL 2: Japanese Patent Application Laid-Open No. 2019-28464
PTL 3: Japanese Patent Application Laid-Open No. 2003-323196

### Non-Patent Literature

NPL 1: Georg Heigold et al., “End-to-End Text-Dependent Speaker Verification”, 2016 IEEE International Conference on Acoustics, Speech, and Signal Processing (ICASSP)
NPL 2: Md Sahidullah et al, “Integrated Spoofing Countermeasures and Automatic Speaker Verification: an Evaluation on ASV spoof 2015”, INTERSPEECH, 2016

### SUMMARY OF INVENTION

### Technical Problem

In recent years, models learned by machine learning (hereinafter, referred to simply as “models”) have been increasingly used in speaker authentication systems. One of the security issues with such models is adversarial examples. An adversarial example is data to which a perturbation has been intentionally added, calculated so that a false positive can be derived by the model.

The spoofing attack defense system described in Non-Patent Literature 2 is an effective system for defense against spoofing attacks, but it does not take into account attacks by adversarial examples.

In addition, the technique described in Patent Literature 1 is a technique to counter unauthorized voice input, but it does not take into account attacks by adversarial examples.

Therefore, it is an object of the present invention to provide a speaker authentication system, a speaker authentication method, and a speaker authentication program capable of achieving robustness against adversarial examples.

### Solution to Problem

A speaker authentication system according to the present invention includes a data storage unit which stores data related to voice of a speaker, a plurality of voice processing units which perform speaker authentication based on input voice and the data stored in the data storage unit, and a post-processing unit which specifies one speaker authentication result based on speaker authentication results obtained respectively by the plurality of the voice processing units, wherein each voice processing unit includes, a pre-processing unit which performs pre-processing for the voice, a feature extraction unit which extracts features from voice data obtained by the pre-processing, a similarity calculation unit which calculates a similarity between the features and features obtained from the data stored in the data storage unit, and an authentication unit which performs speaker authentication based on the similarity calculated by the similarity calculation unit, and wherein a method or parameters of the pre-processing are different for each pre-processing unit included in each voice processing unit.

A speaker authentication system according to the present invention includes a data storage unit which stores data related to voice of a speaker, a plurality of voice processing units which calculate a similarity between features obtained from input voice and features obtained from the data stored in the data storage unit, and an authentication unit which performs speaker authentication based on the similarity obtained respectively by the plurality of the voice processing units, wherein each voice processing unit includes, a pre-processing unit which performs pre-processing for voice, a feature extraction unit which extracts features from voice data obtained by the pre-processing, and a similarity calculation unit which calculates the similarity between the features and the features obtained from the data stored in the data storage unit, and wherein a method or parameters of the pre-processing are different for each pre-processing unit included in each voice processing unit.

In a speaker authentication method according to the present invention, a plurality of voice processing units respectively perform speaker authentication based on input voice and data stored in a data storage unit which stores the data related to voice of a speaker, and a post-processing unit specifies one speaker authentication result based on speaker authentication results obtained respectively by the plurality of the voice processing units, wherein each voice processing unit performs pre-processing for voice, extracts features from voice data obtained by the pre-processing, calculates a similarity between the features and features obtained from the data stored in the data storage unit, and performs speaker authentication based on the calculated similarity, and wherein a method or parameters of the pre-processing are different for each voice processing unit.

In a speaker authentication method according to the present invention, a plurality of voice processing units respectively calculates a similarity between features obtained from input voice and features obtained from data stored in a data storage unit which stores the data related to voice of a speaker, and an authentication unit performs speaker authentication based on the similarity obtained respectively by the plurality of the voice processing units, wherein each voice processing unit performs pre-processing for voice, extracts features from voice data obtained by the pre-processing, and calculates the similarity between the features and features obtained from the data stored in the data storage unit, and wherein a method or parameters of the pre-processing are different for each voice processing unit.

A speaker authentication program according to the present invention makes a computer, including a data storage unit which stores data related to voice of a speaker, function as a speaker authentication system comprising a plurality of voice processing units which perform speaker authentication based on input voice and the data stored in the data storage unit, and a post-processing unit which specifies one speaker authentication result based on speaker authentication results obtained respectively by the plurality of the voice processing units, wherein the program makes each voice processing unit function as a pre-processing unit which performs pre-processing for the voice, a feature extraction unit which extracts features from voice data obtained by the pre-processing, a similarity calculation unit which calculates a similarity between the features and features obtained from the data stored in the data storage unit, and an authentication unit which performs speaker authentication based on the similarity calculated by the similarity calculation unit, and wherein a method or parameters of the pre-processing are different for each pre-processing unit included in each voice processing unit.

A speaker authentication program according to the present invention makes a computer, including a data storage unit which stores data related to voice of a speaker, function as a speaker authentication system comprising a plurality of voice processing units which calculate a similarity between features obtained from input voice and features obtained from the data stored in the data storage unit, and an authentication unit which performs speaker authentication based on the similarity obtained respectively by the plurality of the voice processing units, wherein the program makes each voice processing unit function as a pre-processing unit which performs pre-processing for voice, a feature extraction unit which extracts features from voice data obtained by the pre-processing, and a similarity calculation unit which calculates the similarity between the features and the features obtained from the data stored in the data storage unit, and wherein a method or parameters of the pre-processing are different for each pre-processing unit included in each voice processing unit.

### Advantageous Effects of Invention

According to the present invention, it is possible to achieve robustness against adversarial examples.

### BRIEF DESCRIPTION OF DRAWINGS

FIG. 1 It depicts a graph showing an experimental result of an experiment to check an attack success rate on adversarial examples in multiple speaker authentication systems with different dimensionality of mel filter in pre-processing.

FIG. 2 It depicts a block diagram showing a configuration example of a speaker authentication system of an example embodiment of the present invention.

FIG. 3 It depicts a flowchart showing an example of the processing process of the first example embodiment.

FIG. 4 It depicts a summarized block diagram showing a configuration example of a computer that realizes a speaker authentication system with each voice processing unit, a data storage unit, and a post-processing unit.

FIG. 5 It depicts a block diagram showing a configuration example of a speaker authentication system of the second example embodiment of the present invention.

FIG. 6 It depicts a flowchart showing an example of the processing process of the second example embodiment.

FIG. 7 It depicts a block diagram showing a specific example of the configuration of a speaker authentication system of the first example embodiment.

FIG. 8 It depicts a flowchart showing an example of the processing process in the specific example shown in FIG. 7.

FIG. 9 It depicts a block diagram showing an example of an overview of a speaker authentication system of the present invention.

FIG. 10 It depicts a block diagram showing another example of an overview of a speaker authentication system of the present invention.

FIG. 11 It depicts a block diagram showing an example of a general speaker authentication system.

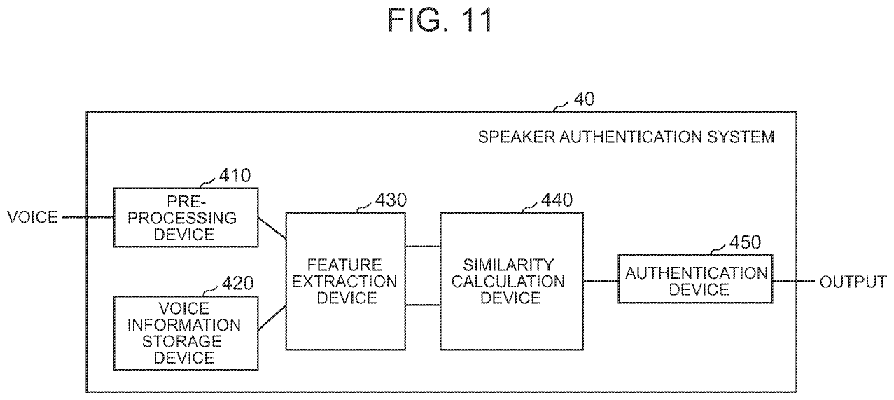

FIG. 12 It depicts a schematic diagram showing a spoofing attack defense system described in Non-Patent Literature 2.

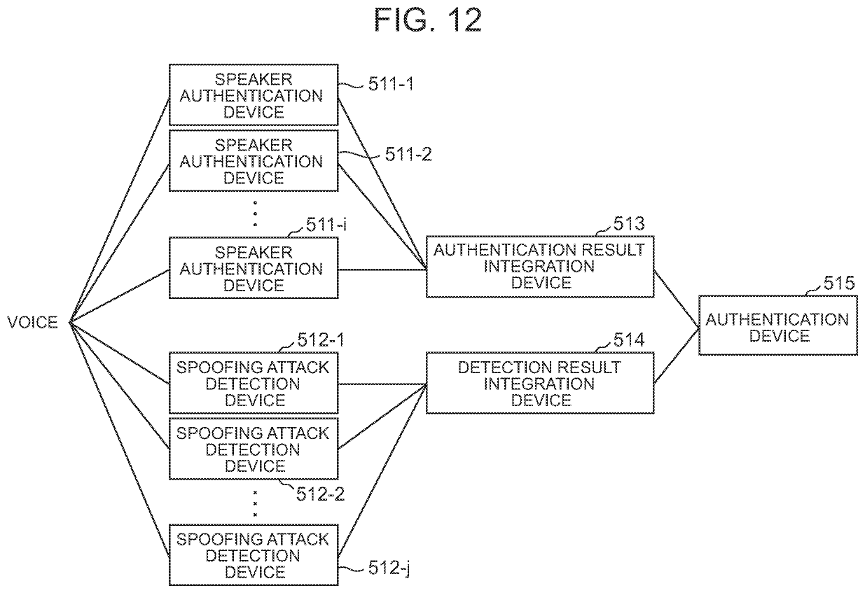

### EXAMPLE EMBODIMENTS

First, the examination conducted by the inventor of the present invention will be described.

As mentioned above, in recent years, models learned by machine learning have been increasingly used in speaker authentication systems. One of the security issues with such models is adversarial examples. As already described, an adversarial example is data to which a perturbation has been intentionally added, calculated so that a false positive can be derived by the model. Adversarial sample is a problem that can arise in any model learned by machine learning, and to date, no model has been proposed that is unaffected by adversarial samples. Therefore, a method to ensure robustness against adversarial samples, especially in the image domain, by adding a defense technique against adversarial samples similar to the technique described in Non-Patent Literature 2, has been proposed. However, when heuristic knowledge of the generation method of the adversarial sample is used in the defense technique, it has been reported that the adversarial sample generated by a different generation method can be easily attacked successfully. Therefore, it is highly desirable that defense techniques against adversarial samples do not use heuristic knowledge about adversarial samples.

One of the properties of adversarial samples is transferability. Transferability is the property that an adversarial sample generated to attack a model can also attack another model that performs the same task as the model. By using transferability, an attacker can attack the model to be attacked by preparing another model that performs the same task as the model and generating adversarial samples against the model, even if the model to be attacked cannot be directly obtained or operated.

In many speaker authentication systems, the voice to be authenticated is not treated as a voice waveform, but treated in the form of data converted into the frequency domain by performing a short-time Fourier transform or the like in the pre-processing for the voice. In addition, various filters are often applied. One type of filter is the mel filter. The inventor have experimentally shown that when individual pre-processing devices in individual speaker authentication systems apply different dimensional mel filters to voice, even if the attack success rate of adversarial samples is high in one speaker authentication system, the attack success rate of the adversarial sample can be significantly reduced in another speaker authentication system where the dimensionality of the mel filter is different. In other words, the inventor experimentally showed that the transferability can be significantly reduced when the dimensionality of the mel filter in the pre-processing is different.

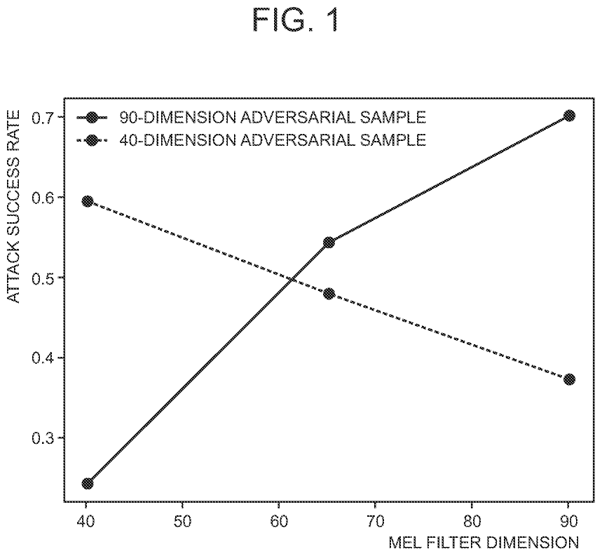

FIG. 1 is a graph showing an experimental result of an experiment to check an attack success rate on adversarial examples in multiple speaker authentication systems with different dimensionality of mel filter in pre-processing. In this experiment, three speaker authentication systems were used. The configuration of the three speaker authentication systems is the same, but the dimensionality of the mel filter in the pre-processing is 40, 65, 90 which are different from each other.

Among the three speaker authentication systems, adversarial samples using the speaker authentication system with a mel filter of 90 dimension are generated, and the change in the attack success rate when the adversarial samples are used to attack the above three speaker authentication systems is shown as a solid line in FIG. 1. The attack success rate of the adversarial samples against the speaker authentication system having a mel filter of 90 dimension is high, but it can be seen from FIG. 1 that the attack success rate decreases as the dimensionality decreases from 90 to 65 and 40.

Among the three speaker authentication systems, adversarial samples using the speaker authentication system with a mel filter of 40 dimension are generated, and the change in the attack success rate when the adversarial samples are used to attack the three speaker authentication systems is shown as a dashed line in FIG. 1. The attack success rate of the adversarial samples against the speaker authentication system with a mel filter of 40 dimension is high, but it can be seen from FIG. 1 that the attack success rate decreases as the dimensionality increases from 40 to 65 and 90.

Based on the findings, the inventor made the following invention.

Hereinafter, example embodiments of the present invention will be explained with reference to the drawings.

### Example Embodiment 1

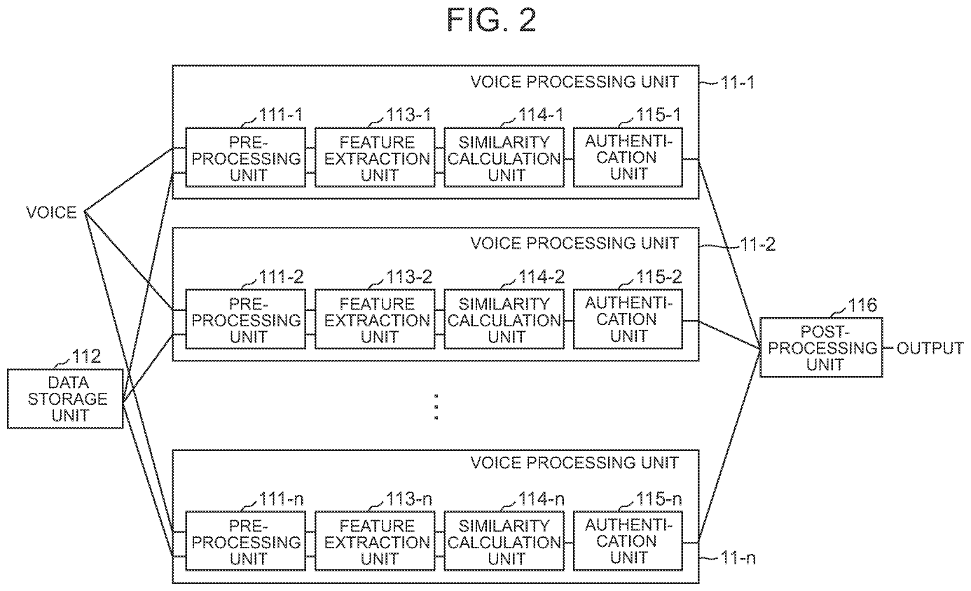

FIG. 2 is a block diagram showing a configuration example of a speaker authentication system of the first example embodiment of the present invention. The speaker authentication system of the first example embodiment comprises a plurality of voice processing units 11-1 to 11-n, a data storage unit 112, and a post-processing unit 116. In the case where individual voice processing units are not specifically distinguished, the code “11” is used to denote the voice processing unit without “4”, “−2”, . . . , and “-n”. The same applies to the code representing each element included in the voice processing unit 11.

In this example, the number of voice processing units 11 is n (refer to FIG. 2).

Common voice is input to each voice processing unit 11, and each voice processing unit 11 performs speaker authentication for the voice. Specifically, each voice processing unit 11 performs a process to determine the speaker of the voice.

Each individual voice processing unit 11 includes a pre-processing unit 111, a feature extraction unit 113, a similarity calculation unit 114, and an authentication unit 115. For example, the voice processing unit 11-1 includes a pre-processing unit 111-1, a feature extraction unit 113-1, a similarity calculation unit 114-1, and an authentication unit 115-1.

In this example, it is assumed that each of the voice processing units 11-1 to 11-n, the data storage unit 112, and the post-processing unit 116 are realized by individual computers. Each of the voice processing unit 11-1 to 11-n, the data storage unit 112, and the post-processing unit 116 are communicatively connected. However, aspects of the voice processing units 11-1 to 11-n, the data storage unit 112, and the post-processing unit 116 are not limited to such example.

The pre-processing units 111-1 to 111-n installed in each of the voice processing units 11-1 to 11-n performs pre-processing on voice. However, a method or parameters of the pre-processing are different for each pre-processing unit 111-1 to 111-n. In other words, the method or parameters of the pre-processing are different for each individual pre-processing unit 111. Therefore, in this example, there are n types of pre-processing.

For example, each pre-processing unit 111 performs pre-processing by applying a short-time Fourier transform to the voice (more specifically, voice waveform data) input through a microphone, and then applying a mel filter to the result. The dimensionality of the mel filter is different for each pre-processing unit 111. Since the dimensionality of the mel filter differs for each pre-processing unit 111, the pre-processing performed on the voice differs for each pre-processing unit 111.

An aspect in which the method or parameters of the pre-processing are different for each pre-processing unit 111 is not limited to the above example. The method or parameters of the pre-processing may be different for each pre-processing unit 111 in other aspects.

The data storage unit 112 stores data related to voice for one or more speakers, for each speaker. Here, data related to voice is data from which features expressing the characteristics of voice of the speaker can be derived.

The data storage unit 112 may store, for each speaker, voice input through the microphone (more specifically, voice waveform data). Alternatively, the data storage unit 112 may store, for each speaker, data obtained by applying pre-processing to the voice waveform data. Alternatively, the data storage unit 112 may store, for each speaker, the features themselves extracted from data obtained by applying pre-processing to the voice waveform data, or data in a form obtained by applying an operation to the features.

As mentioned above, there are n types of pre-processing. Therefore, when storing data obtained after the pre-processing of voice waveform data, the data storage unit 112 stores n types of data per speaker. In other words, n types of data are stored in the data storage unit 112 for each speaker.

When voice (voice waveform data) before the pre-processing is performed is stored in the data storage unit 112, the data that does not depend on pre-processing will be stored. Therefore, in this case, it is sufficient to store one type of voice waveform data for each speaker in the data storage unit 112. In the following description, for the sake of simplicity the description, first, a case where one type of voice waveform data is stored for each speaker in the data storage unit 112 will be explained as an example. FIG. 2 illustrates the case where each pre-processing unit 111 obtains data from the data storage unit 112 in this case. The case where data obtained after pre-processing for voice waveform data is stored in the data storage unit 112 will be described later.

As mentioned above, common voice is input to each voice processing unit 11, and each voice processing unit 11 performs speaker authentication on the voice. In other words, each voice processing unit 11 determines the voice from which speaker is input among the speakers whose data is stored in the data storage unit 112.

Each of the pre-processing units 111-1 to 111-n perform, as pre-processing, the process of transforming the input voice into a format that is easy for the feature extraction unit 113 to extract the features of the voice. An example of this pre-processing is the process of applying a short-time Fourier transform to voice (voice waveform data) and then applying a mel filter to the result, for example. However, in this example embodiment, the dimensionality of the mel filter in the pre-processing unit 111-1 to 111-n is different from each other. In other words, the dimensionality of the mel filter is different for each pre-processing unit 111.

Examples of pre-processing are not limited to the above example. In addition, as already described, the aspect in which the method or parameters of the pre-processing are different for each pre-processing unit 111 is not limited to the above example.

When each pre-processing unit 111 pre-processes the input voice (voice waveform data), the pre-processing unit 111 also pre-processes the voice (voice waveform data) of each speaker stored in the data storage unit 112. As a result, one voice processing unit 111 obtains a result of pre-processing for the input voice waveform data and a result of pre-processing for each voice waveform data of each speaker. The same is true for each of the other voice processing units 11.

Each feature extraction unit 113 extracts voice features from the result of pre-processing on the input voice waveform data. Similarly, each feature extraction unit 113 extracts voice features from the result of pre-processing performed by the pre-processing unit 111 for each speaker (hereinafter, referred to as registered speakers) whose data is stored in the data storage unit 112. As a result, in one voice processing unit 11, features of the input voice and features of the respective voice for each registered speaker are obtained. The same is true for each of the other voice processing units 11.

Each feature extraction unit 113 may extract features using a model obtained by machine learning, for example, or by performing statistical operation processing. However, the method of extracting features from the results of pre-processing is not limited to these methods, but may be other methods.

Each similarity calculation unit 114 calculates, for each registered speaker, the similarity between the features of the input voice and the features of the voice of the registered speaker. As a result, in one voice processing unit 11, a similarity is obtained for each registered speaker. The same is true for each of the other voice processing units 11.

Each similarity calculation unit 114 may calculate, as the similarity, a cosine similarity between the features of the input voice and the features of the voice of the registered speaker. Each similarity calculation unit 114 may also calculate, as the similarity, a reciprocal of the distance between the features of the input voice and the features of the voice of the registered speaker. However, the method of calculating the similarity is not limited to these methods, and other methods may also be used.

Each authentication unit 115 performs speaker authentication based on the similarity calculated for each registered speaker. In other words, each authentication unit 115 determines which voice of a speaker is the input voice among the registered speakers.

Each authentication unit 115 may, for example, compare the similarity calculated for each registered speaker with a threshold value, and identify the speaker whose similarity is greater than a threshold value as the speaker who emitted the input voice. If there is more than one speaker whose similarity is greater than the threshold value, each authentication unit 115 may identify the speaker whose similarity is the greatest among the speakers as the speaker who emitted the input voice.

The above threshold value may be a fixed value or a variable value that varies according to a predetermined calculation method.

In each voice processing unit 11-1 to 11-n, the authentication unit 115-1 to 115-n perform speaker authentication, so that the determination result of the speaker who emitted the input voice can be obtained for each voice processing unit 11. Here, since the pre-processing is different in each voice processing unit 11, the determination result of the speaker obtained in each voice processing unit 11 is not necessarily the same.

The post-processing unit 116 obtains the speaker authentication results from the authentication units 115-1 to 115-n, and specifies one speaker authentication result based on the speaker authentication results obtained by each of the authentication units 115-1 to 115-n. The post-processing unit 116 outputs the specified speaker authentication result to an output device (not shown in FIG. 2).

For example, the post-processing unit 116 may determine the speaker who emitted the input voice by majority voting based on the speaker authentication results obtained by each of the authentication units 115-1 to 115-n. In other words, the post-processing unit 116 may determine the speaker with the largest number of selected speakers among the speakers selected as the speaker authentication results in each of the authentication units 115-1 to 115-n as the speaker who emitted the input voice. However, the method by which the post-processing unit 116 specifies the single speaker authentication result is not limited to majority voting, and may be other methods.

In this example, each of the authentication units 115-1 to 115-n perform speaker authentication, and the post-processing unit 116 specifies the single speaker authentication result based on the speaker authentication results obtained by each of the authentication units 115-1 to 115-n. In this example, the speaker authentication system includes a plurality of elements (voice processing unit 11) that perform speaker authentication, and the speaker authentication system as a whole specifies the single speaker authentication result.

The speaker authentication system of the example embodiment of the present invention can also be used as a detection system for adversarial examples by using the differences of the pre-processing units 111-1 to 111-n. In other words, the speaker authentication system of the example embodiment of the present invention can also be used as a system for determining whether the input voice is adversarial or natural voice. In this case, for example, the post-processing unit 116 may determine that the input voice is an adversarial sample if the speaker authentication results in all the voice processing units 11-1 to 11-n do not match. However, the criteria for determining that the input voice is an adversarial sample is not limited to the above example.

In this example, each voice processing unit 11 is realized by a computer. In this case, the pre-processing unit 111, the feature extraction unit 113, the similarity calculation unit 114, and the authentication unit 115 in each voice processing unit 11 are realized by a CPU (Central Processing Unit) of a computer operating according to a voice processing program, for example. In this case, the CPU can read the voice processing program from a program storage medium such as a program storage device of the computer, and operate as the pre-processing unit 111, the feature extraction unit 113, the similarity calculation unit 114, and the authentication unit 115 according to the program.

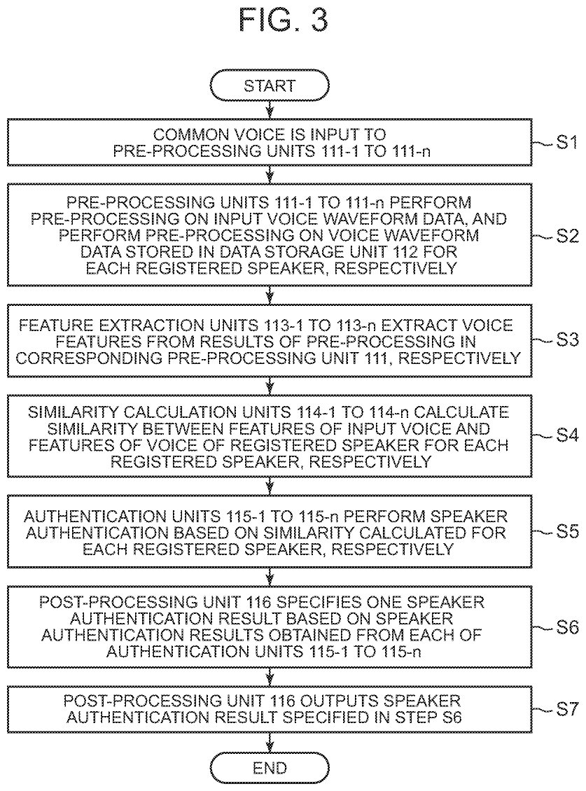

Next, the processing process of the first example embodiment will be explained. FIG. 3 is a flowchart showing an example of the processing process of the first example embodiment. The matters already explained are omitted as appropriate.

First, common voice (voice waveform data) is input to the pre-processing unit 111-1 to 111-n (step S1).

Next, the pre-processing units 111-1 to 111-n perform pre-processing on the input voice waveform data, respectively (step S2). In addition, in step S2, the pre-processing units 111-1 to 111-n obtain the voice waveform data stored in the data storage unit 112 for each registered speaker and perform pre-processing on the obtained voice waveform data, respectively.

As mentioned above, the method or parameters of the pre-processing are different for each individual pre-processing unit 111. For example, the dimensionality of the mel filter used in pre-processing is different, for each pre-processing unit 111.

Next to step S2, the feature extraction units 113-1 to 113-n extract voice features from the results of the pre-processing in the corresponding pre-processing unit 111, respectively (step S3).

For example, the feature extraction unit 113-1 extracts the features of the input voice from the result of the pre-processing performed by the pre-processing unit 111-1 on the input voice waveform data. The feature extraction unit 113-1 extracts the features of the voice from the results of the pre-processing performed by the pre-processing unit 111-1 on the voice waveform data stored in the data storage unit 112, for each registered speaker. The other respective feature extraction units 113 operate in the same manner.

Next to step S3, the similarity calculation units 114-1 to 114-n calculate a similarity between the features of the input voice and the features of the voice of the registered speaker for each registered speaker, respectively (step S4).

Next, the authentication units 115-1 to 115-n perform speaker authentication based on the similarity calculated for each registered speaker, respectively (step S5). In other words, the authentication units 115-1 to 115-n determine which voice of a speaker is the input voice among the registered speakers, respectively.

Next, the post-processing unit 116 obtains the speaker authentication results from the authentication units 115-1 to 115-n, and specifies one speaker authentication result based on the speaker authentication results obtained from each of the authentication units 115-1 to 115-n (step S6). For example, the post-processing unit 116 may determine the speaker with the largest number of selected speakers among the speakers selected as a speaker authentication result by each of the authentication units 115-1 to 115-n as the speaker who emitted the input voice.

Next, the post-processing unit 116 outputs the speaker authentication result specified in step S6 to an output device (not shown in FIG. 2) (step S7). The aspect of output in step S7 is not particularly limited. For example, the post-processing unit 116 may display the speaker authentication result specified in step S6 on a display device (not shown in FIG. 2).

In the first example embodiment, the method or parameters of the pre-processing are different for each pre-processing unit 111 included in each voice processing unit 11. Therefore, even if the attack success rate of an adversarial sample is high in one voice processing unit 11, the attack success rate of the adversarial samples will be reduced in other voice processing units 11. Accordingly, the voice authentication result obtained in the voice processing unit 11 with a high attack success rate for the adversarial samples is not ultimately selected by the post-processing unit 116. Therefore, robustness against adversarial examples can be achieved. In addition, in this example embodiment, by changing the method or parameters of the pre-processing for each pre-processing unit 11, the success rate of attacks on multiple voice processing units 11 is made different. By doing so, the robustness against adversarial examples is enhanced. Therefore, no heuristic knowledge of known adversarial samples is used to increase the robustness against adversarial samples. As a result, according to this example embodiment, robustness can be ensured even against unknown adversarial samples.

As mentioned above, the speaker authentication system of this example embodiment can also be used as a detection system for adversarial examples by using the differences in the pre-processing units 111-1 to 111-n. For example, the speaker authentication system can also be used as such a detection system by determining that the input voice is an adversarial sample if the speaker authentication results in all voice processing units 11-1 to 11-n do not match, by the post-processing unit 116. As already explained, the criteria for determining that the input voice is an adversarial sample is not limited to the above example.

In the above description, such a case where the data storage unit 112 stores the voice (voice waveform data) input through the microphone for each speaker is explained as an example. As already explained, the data storage unit 112 may store data obtained after pre-processing of the voice waveform data. This case will be explained below.

The case where the data storage unit 112 stores the data obtained by applying pre-processing to the voice waveform data for each speaker will be explained. Each pre-processing unit 111 has a different pre-processing method or parameters. In other words, there are n types of pre-processing. Because of that, when focusing on a single speaker, the data obtained by applying each of the n types of pre-processing to the voice waveform data of the single speaker (referred to as p) should be prepared. Specifically, “data obtained by applying the pre-processing of the pre-processing unit 111-1 to the voice waveform data of speaker p”, “data obtained by applying the pre-processing of the pre-processing unit 111-2 to the voice waveform data of speaker p”, . . . , “data obtained by applying the pre-processing of the pre-processing unit 111-n to the voice waveform data of speaker p” are prepared. As a result, n types of data for speaker p can be obtained. In the same way, n types of data are prepared for each speaker other than speaker p. In this way, n types of data can be prepared for each speaker, and the n types of data for each individual speaker may be stored in the data storage unit 112.

In the above example, when the voice processing unit 11 obtains the data stored in the data storage unit 112, the feature extraction unit 113 may obtain the data obtained by performing the pre-processing of the pre-processing unit 111 corresponding to the feature extraction unit 113 from the data storage unit 112 and extract the features from the data, for each registered speaker.

For example, when the voice processing unit 11-1 obtains the data stored in the data storage unit 112, the feature extraction unit 113-1 may obtain the data obtained by performing the pre-processing of the pre-processing unit 111-1 from the data storage unit 112 and extract the features from the data, for each registered speaker. The same applies when the other voice processing unit 11 obtains the data stored in the data storage unit 112.

Next, the case where the data storage unit 112 stores the features themselves extracted from the data obtained by pre-processing the voice waveform data for each speaker will be explained. In this case also, n types of data (features) per person may be prepared, and each of the n types of data for each individual speaker may be stored in the data storage unit 112. For example, n types of data for speaker p can be stored in the data storage unit 112. For example, as the n types of data for speaker p, “features extracted from the pre-processing results of the pre-processing unit 111-1 on the voice waveform data of speaker p”, “features extracted from the pre-processing results of the pre-processing unit 111-2 on the voice waveform data of speaker p” . . . , “features extracted from the pre-processing results of the pre-processing unit 111-n on the voice waveform data of speaker p” are prepared. In the same way, n types of data (features) per person are prepared for each speaker other than speaker p. In this way, n types of data (features) may be prepared for each speaker, and each of the n types of data for each individual speaker may be stored in the data storage unit 112.

In the above example, the data storage unit 112 stores data related to the voice in the format of features. Therefore, when the voice processing unit 11 obtains the data stored in the data storage unit 112, the similarity calculation unit 114 may obtain the features corresponding to the pre-processing of the pre-processing unit 111 corresponding to the feature extraction unit 113 from the data storage unit 112, for each registered speaker. Then, the similarity calculation unit 114 may calculate a similarity between the features and the features of the voice input to the voice processing unit 11.

For example, when the voice processing unit 11-1 obtains the features stored in the data storage unit 112, the similarity calculation unit 114-1 may obtain “features extracted from the pre-processing results of the pre-processing unit 111-1 on the voice waveform data of speaker” from the data storage unit 112, for each registered speaker. Then, the similarity calculation unit 114-1 may calculate a similarity between the features and the features of the voice input to the voice processing unit 11-1. The same applies when the other voice processing unit 11 obtains the features stored in the data storage unit 112.

In the first example embodiment described above, each of the voice processing units 11-1 to 11-n, the data storage unit 112, and the post-processing unit 116 is realized by separate computers as an example. In the following, the case where the speaker authentication system comprising each voice processing unit 11-1 to 11-n, the data storage unit 112, and the post-processing unit 116 is realized by a single computer will be explained.

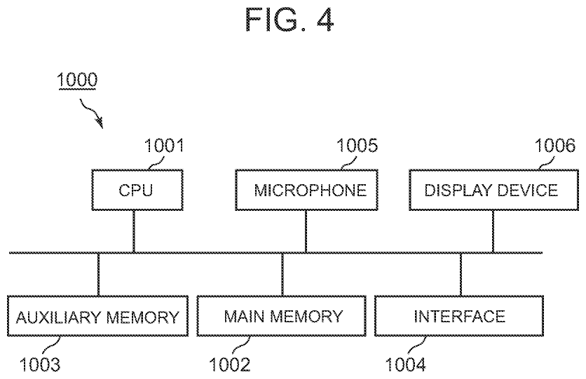

FIG. 4 is a summarized block diagram showing a configuration example of a single computer that realizes a speaker authentication system comprising each voice processing unit 11-1 to 11-n, the data storage unit 112, and the post-processing unit 116. The computer 1000 comprises a CPU 1001, a main memory 1002, an auxiliary memory 1003, an interface 1004, a microphone 1005, and a display device 1006.

Microphone 1005 is an input device used for voice input. The input device used for voice input may be a device other than the microphone 1005.

The display device 1006 is used to display the speaker authentication result specified in step S6 (refer to FIG. 3) above. However, as mentioned above, the output aspect in step S7 (refer to FIG. 3) is not limited.

The operations of the speaker authentication system comprising each voice processing unit 11-1 to 11-n, the data storage unit 112, and the post-processing unit 116 is stored in the format of a program in the auxiliary memory 1003. Hereinafter, this program is referred to as a speaker authentication program. The CPU 1001 reads the speaker authentication program from the auxiliary memory 1003 and expands it to the main memory 1002, and according to the speaker authentication program, operates as the plurality of voice processing units 11-1 to 11-n and the post-processing unit 116 in the first example embodiment. The data storage unit 112 may be realized by the auxiliary memory 1003, or by other storage devices provided by the computer 1000.

The auxiliary storage device 1003 is an example of a non-transitory tangible medium. Other examples of non-transitory tangible media include magnetic disks, optical magnetic disks, CD-ROM (Compact Disk Read Only Memory), DVD-ROM (Digital Versatile Disk Read Only Memory), semiconductor memory, and the like, which are connected through an interface 1004.

When the speaker authentication program is delivered to the computer 1000 through a communication line, the computer 1000 receiving the delivery may expand the speaker authentication program into the main memory device 1002 and operate as the plurality of voice processing units 11-1 to 11-n and the post-processing unit 116 in the first example embodiment.

### Example Embodiment 2

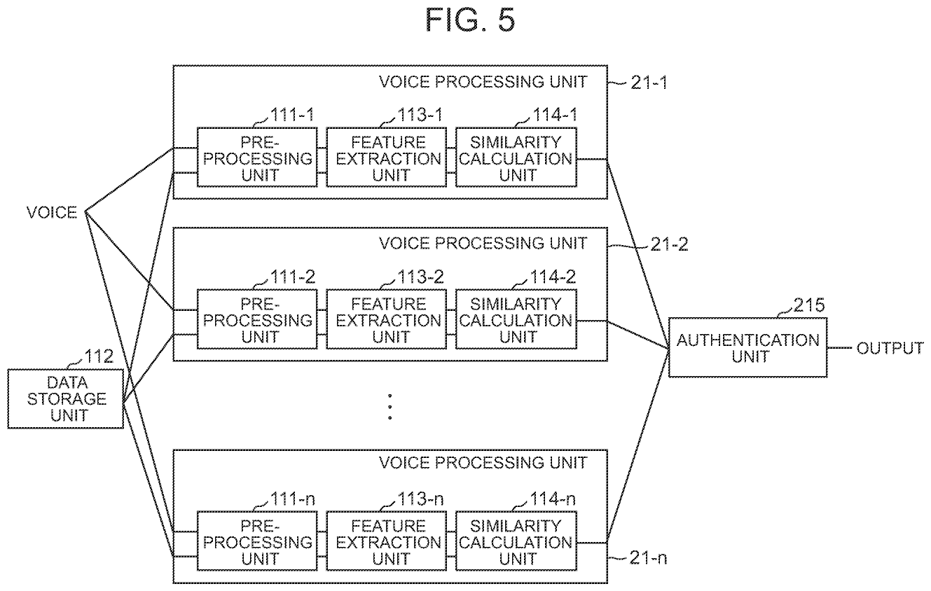

FIG. 5 is a block diagram showing a configuration example of a speaker authentication system of the second example embodiment of the present invention. Elements similar to those of the first example embodiment are marked with the same code as in FIG. 2, and a detailed description is omitted. The speaker authentication system of the second example embodiment comprises a plurality of voice processing units 21-1 to 21-n, a data storage unit 112, and an authentication unit 215. In the case where individual voice processing units are not specifically distinguished, the code “21” is used to denote the voice processing unit without “4”, “−2”, . . . , and “-n”. The same applies to the code representing each element included in the voice processing unit 21.

In this example, the number of voice processing units 21 is n (refer to FIG. 5).

Common voice is input to each voice processing unit 21, and each voice processing unit 21 calculates a similarity between features of the input voice and features of each registered speaker (features obtained from the data of each speaker stored in the data storage unit 112).

As described below, each voice processing unit 21 includes the pre-processing unit 111. The method or parameters of the pre-processing are different for each individual pre-processing unit 111.

The data storage unit 112 stores data related to voice for one or more speakers for each speaker, similar to the data storage unit 112 in the first example embodiment.

The data storage unit 112 may store, for each speaker, voice input through the microphone (more specifically, voice waveform data). Alternatively, the data storage unit 112 may store, for each speaker, data obtained by applying pre-processing to the voice waveform data. Alternatively, the data storage unit 112 may store, for each speaker, the features themselves extracted from data obtained by applying pre-processing to the voice waveform data, or data in a form obtained by applying an operation to the features.

When the data storage unit 112 stores the data obtained by applying pre-processing to the voice waveform data for each speaker, n types of data may be prepared for each speaker, and the n types of data of each individual speaker may be stored in the data storage unit 112.

When the data storage unit 112 stores the features themselves extracted from the data obtained by applying pre-processing to the voice waveform data for each speaker, n types of data (features) may be prepared for each speaker, and the n types of features of each speaker may be stored in the data storage unit 112.

In the case where the data storage unit 112 stores voice (voice waveform data) before pre-processing is performed, it is sufficient to store one type of voice waveform data for each speaker in the data storage unit 112.

Since the matters related to these data storage units 112 have been described in the first example embodiment, a detailed explanation is omitted here.

Hereinafter, the case where the data storage unit 112 stores voice (voice waveform data) before the pre-processing is performed will be explained.

Each of the voice processing units 21 includes the pre-processing unit 111, the feature extraction unit 113, and the similarity calculation unit 114. For example, the voice processing unit 21-1 includes the pre-processing unit 111-1, the feature extraction unit 113-1, and the similarity calculation unit 114-1.

In this example, it is assumed that each of the voice processing units 21-1 to 21-n, the data storage unit 112, and the authentication unit 215 are realized by separate computers. Each of the voice processing units 21-1 to 21-n, the data storage unit 112, and the authentication unit 215 are communicatively connected. However, aspects of the voice processing units 21-1 to 21-n, the data storage unit 112, and the authentication unit 215 are not limited to such example.

The pre-processing units 111-1 to 111-n are the same as the pre-processing units 111-1 to 111-n in the first example embodiment. As explained in the first example embodiment, each of the pre-processing units 111-1 to 111-n performs, as pre-processing, the process of converting the input voice into a format in which the feature extraction unit 113 can easily extract the features of the voice. An example of this pre-processing is the process of applying a short-time Fourier transform to the voice (voice waveform data) and then applying a mel filter to the result, for example. Here, the method or parameters of the pre-processing are different for each pre-processing unit 111. In this example, the dimensionality of the mel filter in the pre-processing units 111-1 to 111-n is assumed to be different. In other words, the dimensionality of the mel filter is assumed to be different for each pre-processing unit 111.

Examples of pre-processing are not limited to the above examples. The aspect in which the method or parameters of the pre-processing are different for each pre-processing unit 111 is not limited to the above example.

When each pre-processing unit 111 pre-processes the input voice (voice waveform data), the pre-processing unit 111 also pre-processes the voice (voice waveform data) of each speaker stored in the data storage unit 112.

Each feature extraction unit 113 is the same as each feature extraction unit 113 in the first example embodiment. Each feature extraction unit 113 extracts voice features from a result of pre-processing on the input voice waveform data. Similarly, each feature extraction unit 113 extracts voice features from a result of pre-processing performed by the pre-processing unit 111 for each registered speaker.

Each feature extraction unit 113 may extract features using a model obtained by machine learning, for example, or by performing statistical operation processing. However, the method of extracting features from the result of pre-processing is not limited to these methods, but may be other methods.

Each similarity calculation unit 114 calculates, for each registered speaker, a similarity between the features of the input voice and the features of the voice of the registered speaker.

Each similarity calculation unit 114 may calculate, as the similarity, a cosine similarity between the features of the input voice and the features of the voice of the registered speaker.

Each similarity calculation unit 114 may also calculate, as the similarity, a reciprocal of the distance between the features of the input voice and the features of the voice of the registered speaker. However, the method of calculating the similarity is not limited to these methods, and other methods may also be used.

The authentication unit 215 performs speaker authentication based on the similarity calculated for each speaker by each voice processing unit 21-1 to 21-n (more specifically, each similarity calculation unit 114-1 to 114-n). In other words, the authentication unit 215 determines which voice of a speaker is the input voice among the registered speakers based on the similarity calculated for each registered speaker in each of the similarity calculation units 114-1 to 114-n. In addition, the authentication unit 215 outputs the speaker authentication result (which voice of a speaker is the input voice) to an output device (not shown in FIG. 5).

An example of the speaker authentication operation performed by the authentication unit 215 will be explained below.

The authentication unit 215 obtains a similarity for each registered speaker from each of the n similarity calculation units 114-1 to 114-n. For example, assume that there are x registered speakers. In this case, the authentication unit 215 obtains the similarity of x speakers from the similarity calculation unit 114-1. Similarly, the authentication unit 215 obtains the similarity of x speakers from the similarity calculation units 114-2 to 114-n.

The authentication unit 215 holds each threshold value for each individual pre-processing unit 111-1 to 111-n. In other words, the authentication unit 215 holds a threshold value corresponding to the pre-processing unit 111-1 (Th1), a threshold value corresponding to the pre-processing unit 111-2 (Th2), . . . , a threshold value corresponding to the pre-processing unit 111-n (Thn).

Then, the authentication unit 215 compares, for each voice processing unit 21, each similarity for each of x persons obtained from the similarity calculation unit 114 in the voice processing unit 21 with the threshold value corresponding to the pre-processing unit 111 in the voice processing unit 21. As a result, for a single speaker, n comparison results between the similarity and the threshold value are obtained. The authentication unit 215 may specify the number of comparison results that the similarity is greater than the threshold value for each registered speaker, and use the speaker with the largest number as the speaker authentication result. In other words, the authentication unit 215 may determine that the input voice is the voice of the speaker whose number is the largest.

For example, it is assumed that the speaker p is focused on among the plurality of registered speakers. The authentication unit 215 compares the magnitude relationship between the similarity calculated for speaker p, obtained from the similarity calculation unit 114-1, and the threshold value Th1 corresponding to the pre-processing unit 111-1. Similarly, the authentication unit 215 compares the magnitude relationship between the similarity calculated for speaker p, obtained from the similarity calculation unit 114-2, and the threshold value Th2 corresponding to the pre-processing unit 111-2. The authentication unit 215 performs the same process for the similarity calculated for speaker p, obtained from respective similarities calculation units 114-3 to 114-n. As a result, n comparison results between the similarity and the threshold value are obtained for speaker p.

Here, the case where the speaker p is focused on has been described, but the authentication unit 215 similarly derives n comparison results between the similarity and the threshold value, for each registered speaker.

Then, the authentication unit 215 specifies, for each speaker, the number of comparison results that the similarity is greater than a threshold value. Furthermore, the authentication unit 215 determines that the input voice is the voice of the speaker whose number is the largest.

The speaker authentication operation of the authentication unit 215 is not limited to the above example. In the above example, the case where the authentication unit 215 holds an individual threshold value for each of the individual pre-processing units 111-1 to 111-n has been described as an example. The authentication unit 215 may hold one type of threshold value independent of the pre-processing units 111-1 to 111-n. Hereinafter, an operation example of the authentication unit 215, when the authentication unit 215 holds one type of threshold value, will be shown.

The authentication unit 215 obtains a similarity for each registered speaker from each of the n similarity calculation units 114-1 to 114-n. This point is the same as the above-mentioned case.

Then, the authentication unit 215 calculates an arithmetic mean of the similarities obtained from each of the n similarity calculation units 114-1 to 114-n for each registered speaker. For example, it is assumed that the speaker p is focused on among the plurality of registered speakers. The authentication unit 215 calculates an arithmetic mean of “similarity calculated for speaker p obtained from the similarity calculation unit 114-1”, “similarity calculated for speaker p obtained from the similarity calculation unit 114-2”, . . . , and “similarity calculated for speaker p obtained from the similarity calculation unit 114-n”. As a result, the arithmetic mean of the similarities for speaker p is obtained.

The authentication unit 215 similarly calculates an arithmetic mean of the similarities for each registered speaker.

Then, the authentication unit 215 may compare the arithmetic mean of the similarity calculated for each registered speaker with the held threshold value, for example, and determine the speaker whose arithmetic mean of the similarity is greater than the threshold value as the speaker who emitted the input voice. When there are multiple speakers whose arithmetic mean of similarity is greater than the threshold value, the authentication unit 215 may determine the speaker whose arithmetic mean of similarity is the greatest among the speakers as the speaker who emitted the input voice.

Here, the operation of speaker authentication when the authentication unit 215 holds n types of threshold values and the operation of speaker authentication when the authentication unit 215 holds one type of threshold value have been explained. In the second example embodiment, the authentication unit 215 may identify the speaker who emitted the input voice by a more complex operation based on the similarity for each speaker obtained from each similarity calculation unit 114.

In this example, each voice processing unit 21 is realized by a computer. In this case, the pre-processing unit 111, the feature extraction unit 113, and the similarity calculation unit 114 in each voice processing units 21 are realized by a CPU of a computer operating according to a voice processing program, for example. In this case, the CPU can read a voice processing program from a program storage medium such as a program storage device of the computer, and operate as the pre-processing unit 111, the feature extraction unit 113, and the similarity calculation unit 114 according to the program.

Next, the processing process of the second example embodiment will be explained.

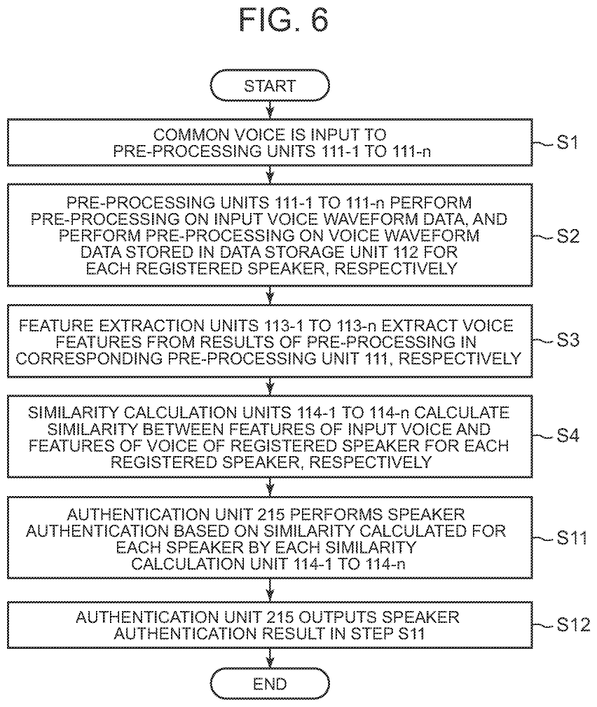

FIG. 6 is a flowchart showing an example of the processing process of the second example embodiment. The matters already described are omitted as appropriate. In addition, the explanation of the same processing as that of the first example embodiment will be omitted.

Steps S1 to S4 are the same as steps S1 to S4 in the first example embodiment, and the explanation thereof will be omitted.

After step S4, the authentication unit 215 performs speaker authentication based on the similarity calculated for each speaker by each similarity calculation unit 114-1 to 114-n (step S11). In step S11, the authentication unit 215 obtains the similarity for each registered speaker from each of the n similarity calculation units 114-1 to 114-n. Then, based on the similarity, the authentication unit 215 determines which voice of a speaker among the registered speakers is the input voice.

Since the example of the operation of this authentication unit 215 has already been explained, it is omitted here.

Next, the authentication unit 215 outputs the speaker authentication result in step S11 to an output device (not shown in FIG. 5). The output aspect in step S12 is not particularly limited. For example, the authentication unit 215 may display the speaker authentication result in step S11 on a display device (not shown in FIG. 5).

In the second example embodiment, as in the first example embodiment, it is possible to realize a speaker authentication system that is robust against adversarial examples. In the first example embodiment, each voice processing unit 11 includes the authentication unit 115 (refer to FIG. 2), but in the second example embodiment, each voice processing unit 21 does not include such an authentication unit. Therefore, in the second example embodiment, each voice processing unit 21 can be simplified.

In addition, the authentication unit 215 can realize speaker authentication in a different method from the first example embodiment, based on the similarity for each speaker obtained from each similarity calculation unit 114.

In the second example embodiment described above, the case where each voice processing unit 21-1 to 21-n, the data storage unit 112, and the authentication unit 215 are realized by separate computers has been explained as an example. In the following, the case where the speaker authentication system includes each voice processing unit 21-1 to 21-n, the data storage unit 112, and the authentication unit 215 is realized by a single computer will be explained as an example. This computer can be represented in the same way as in FIG. 4, and will be explained with reference to FIG. 4.

Microphone 1005 is an input device used for voice input. The input device used for voice input may be a device other than the microphone 1005.

The display device 1006 is used to display the speaker authentication result in the aforementioned step 11. However, as mentioned above, the output aspect in step S12 (refer to FIG. 6) is not particularly limited.

The operation of the speaker authentication system with each voice processing unit 21-1 to 21-n, the data storage unit 112, and authentication unit 215 is stored in the format of a program in the auxiliary memory 1003. In this example, this program is referred to as a speaker authentication program. The CPU 1001 reads the speaker authentication program from the auxiliary memory 1003, and expands it to the main memory 1002, and according to the speaker authentication program, operates as the plurality of voice processing units 21-1 to 21-n and the authentication unit 215 in the second example embodiment. The data storage unit 112 may be realized by the auxiliary memory 1003, or by other storage devices provided by the computer 1000.

### Specific Example

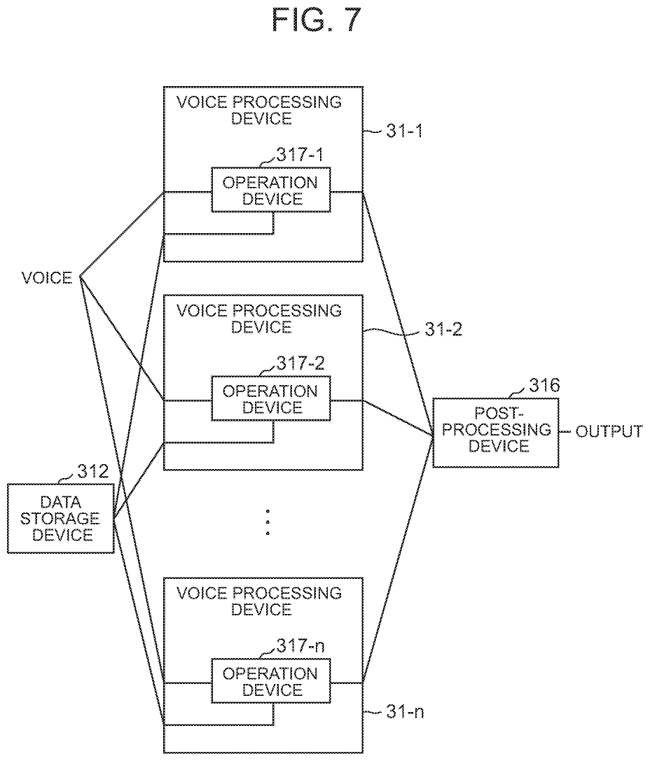

Next, a specific example of the configuration of a speaker authentication system will be explained using the first example embodiment as an example. However, the matters explained in the first example embodiment will be omitted as appropriate. FIG. 7 is a block diagram showing a specific example of the configuration of a speaker authentication system of the first example embodiment. In the example shown in FIG. 7, the speaker authentication system comprises a plurality of voice processing devices 31-1 to 31-n, a data storage device 312, and a post-processing device 316. In the case where individual voice processing devices are not specifically distinguished, the code “31” is used to denote the voice processing device without “-1”, “−2”, . . . , and “-n”. The same applies to the code “317” representing the operation device included in the voice processing device 31.

In this example, it is assumed that the plurality of voice processing devices 31-1 to 31-n and the post-processing device 316 are realized by separate computers. These computers include a CPU, a memory, a network interface, and a magnetic storage device. For example, the voice processing devices 31-1 to 31-n may include a reading device for reading data from a computer-readable recording medium such as a CD-ROM, respectively.

Each of the voice processing device 31 includes an operation device 317. The operation device 317 corresponds to a CPU, for example. Each operation device 317 expands a voice processing program stored in a magnetic storage device of the voice processing unit 31 or the voice processing program received from outside through a network interface in a memory. Then, according to the voice processing program, each operation device 317 realizes the operation as the pre-processing unit 111, the feature extraction unit 113, the similarity calculation unit 114, and the authentication unit 115 (refer to FIG. 2) in the first example embodiment. However, the method or parameters of the pre-processing are different for each operation device 317 (in other words, for each voice processing device 31).

The CPU of the post-processing device 316 expands a program stored in a magnetic storage device of the post-processing device 316 or the program received from outside through a network interface in the memory. Then, according to the program, the CPU realizes the operation as the post-processing unit 116 (refer to FIG. 2) in the first example embodiment.

The data storage device 312 is, for example, a magnetic storage device, etc., which stores data related to voice for one or more speakers for each speaker, and provides the data to each of the operation devices 317-1 to 317-n. The data storage device 312 may be realized by a computer that includes a reading device for reading data from a computer-readable recording medium of a flexible disk or CD-ROM. The recording medium may then store the data related to the voice for each speaker.

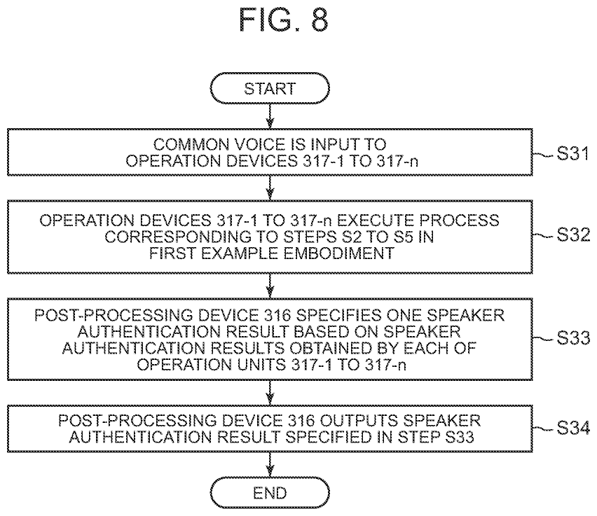

FIG. 8 is a flowchart showing an example of the processing process in the specific example shown in FIG. 7. First, common voice is input to the operation devices 317-1 to 317-n (step S31). Step S31 corresponds to step S1 (refer to FIG. 3) in the first example embodiment.

Then, the operation devices 317-1 to 317-n execute the process corresponding to steps S2 to S5 in the first example embodiment (step S32).

The post-processing device 316 specifies one speaker authentication result based on the speaker authentication results obtained by each of the operation units 317-1 to 317-n (step S33).

Then, the post-processing device 316 outputs the speaker authentication result specified in step S33 to an output device (not shown in FIG. 7) (step S34). The output aspect in step S34 is not particularly limited.

Steps S33 and S34 are equivalent to steps S6 and S7 in the first example embodiment.

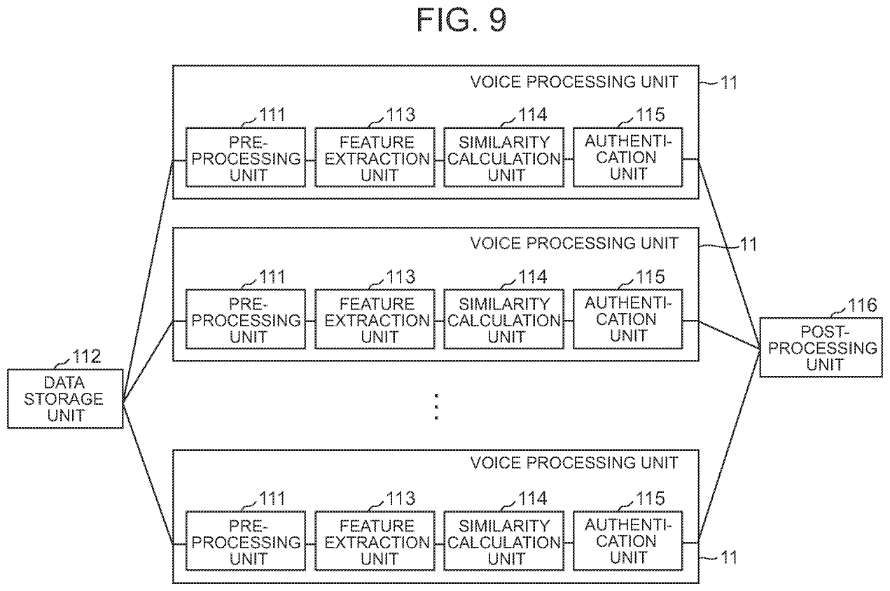

Next, an overview of the present invention will be explained. FIG. 9 is a block diagram showing an example of an overview of a speaker authentication system of the present invention.

A speaker authentication system of the present invention comprises a data storage unit 112, a plurality of voice processing units 11, and a post-processing unit 116.

The data storage unit 112 stores data related to voice of a speaker.

Each of the plurality of voice processing units 11 performs speaker authentication based on input voice and the data stored in the data storage unit 112.

The post-processing unit 116 specifies one speaker authentication result based on speaker authentication results obtained respectively by the plurality of the voice processing units 11.

Each voice processing unit 11 includes a pre-processing unit 111, a feature extraction unit 113, a similarity calculation unit 114, and an authentication unit 115.

The pre-processing unit 111 performs pre-processing for the voice.

The feature extraction unit 113 extracts features from voice data obtained by the pre-processing.

The similarity calculation unit 114 calculates a similarity between the features and features obtained from the data stored in the data storage unit 112.

The authentication unit 115 performs speaker authentication based on the similarity calculated by the similarity calculation unit 114.

The method or parameters of the pre-processing are different for each pre-processing unit 111 included in each voice processing unit 11.

With such a configuration, it is possible to achieve robustness against adversarial examples.

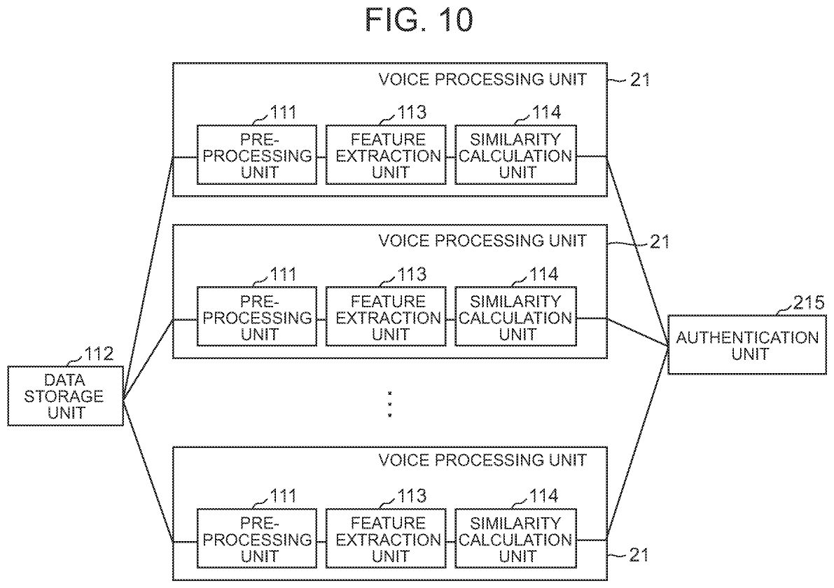

FIG. 10 is a block diagram showing another example of an overview of a speaker authentication system of the present invention.

A speaker authentication system of the present invention comprises a data storage unit 112, a plurality of voice processing units 21, and an authentication unit 215.

The data storage unit 112 stores data related to voice of a speaker.

Each of the plurality of voice processing units 21 calculates a similarity between features obtained from input voice and features obtained from the data stored in the data storage unit 112.

The authentication unit 215 performs speaker authentication based on the similarity obtained respectively by the plurality of voice processing units 21.

Each voice processing unit 21 includes a pre-processing unit 111, a feature extraction unit 113, and a similarity calculation unit 114.

The pre-processing unit 111 performs pre-processing for voice.

The feature extraction unit 113 extracts features from voice data obtained by the pre-processing.

The similarity calculation unit 114 calculates a similarity between the features and the features obtained from the data stored in the data storage unit 112.

The method or parameters of the pre-processing are different for each pre-processing unit 111 included in each voice processing unit 21.

Even with such a configuration, it is possible to achieve robustness against adversarial examples.

In the speaker authentication system summarized in FIGS. 9 and 10, each pre-processing unit may perform the pre-processing applying a mel filter after applying a short-time Fourier transform to the input voice, and the dimensionality of the mel filter is different for each pre-processing unit.

Although the invention of the present application has been described above with reference to the example embodiments, the present invention is not limited to the above example embodiments. Various changes can be made to the configuration and details of the present invention that can be understood by those skilled in the art within the scope of the present invention.

### INDUSTRIAL APPLICABILITY

The present invention is suitably applied to speaker authentication systems.

### REFERENCE SIGNS LIST

11-1 to 11-n Voice processing unit
111-1 to 111-n Pre-processing unit
112 Data storage unit
113-1 to 113-n Feature extraction unit
114-1 to 114-n Similarity calculation unit
115-1 to 115-n Authentication unit
116 Post-processing unit
21-1 to 21-n Voice processing unit
215 Authentication unit

What is claimed is:

1. A speaker authentication system comprising:
a data storage unit which stores data related to voice of a speaker,
a plurality of voice processing units which perform speaker authentication based on input voice and the data stored in the data storage unit, and
a post-processing unit which specifies one speaker authentication result based on speaker authentication results obtained respectively by the plurality of the voice processing units,
wherein
each voice processing unit includes,
a pre-processing unit which performs pre-processing for the voice,
a feature extraction unit which extracts features from voice data obtained by the pre-processing,
a similarity calculation unit which calculates a similarity between the features and features obtained from the data stored in the data storage unit, and
an authentication unit which performs speaker authentication based on the similarity calculated by the similarity calculation unit, and
wherein a method or parameters of the pre-processing are different for each pre-processing unit included in each voice processing unit.

2. A speaker authentication system comprising:
a data storage unit which stores data related to voice of a speaker,
a plurality of voice processing units which calculate a similarity between features obtained from input voice and features obtained from the data stored in the data storage unit, and
an authentication unit which performs speaker authentication based on the similarity obtained respectively by the plurality of the voice processing units,
wherein
each voice processing unit includes,
a pre-processing unit which performs pre-processing for voice,
a feature extraction unit which extracts features from voice data obtained by the pre-processing, and
a similarity calculation unit which calculates the similarity between the features and the features obtained from the data stored in the data storage unit, and
wherein a method or parameters of the pre-processing are different for each pre-processing unit included in each voice processing unit.

3. The speaker authentication system according to claim 1, wherein
each pre-processing unit performs the pre-processing applying a mel filter after applying a short-time Fourier transform to the input voice, and
a dimensionality of the mel filter is different for each pre-processing unit.

4. A speaker authentication method, wherein
a plurality of voice processing units respectively perform speaker authentication based on input voice and data stored in a data storage unit which stores the data related to voice of a speaker, and
a post-processing unit specifies one speaker authentication result based on speaker authentication results obtained respectively by the plurality of the voice processing units,
wherein each voice processing unit
performs pre-processing for voice,
extracts features from voice data obtained by the pre-processing,
calculates a similarity between the features and features obtained from the data stored in the data storage unit, and
performs speaker authentication based on the calculated similarity, and
wherein a method or parameters of the pre-processing are different for each voice processing unit.

5. (canceled)

6. The speaker authentication method according to claim 4, wherein
each voice processing unit performs a processing applying a mel filter after applying a short-time Fourier transform to the input voice, as the pre-processing, and
wherein a dimensionality of the mel filter is different for each voice processing unit.

7. (canceled)

8. (canceled)

9. (canceled)
